(19) United States
(12) Patent Application Publication
(10) Pub. No.: US 2007/0006146 A1
(43) Pub. Date: Jan. 4, 2007

(54) Systems and apparatus for enhanced mobile computing platforms

(76) Inventors: Wah Yin Kwong, Beaverton, OR (US); Prosenjit Ghosh, Portland, OR (US); Katie Mills, Portland, OR (US); Jim Trethewey, Hillsboro, OR (US); Robert Jacobs, Portland, OR (US); Tim Nguyen, Portland, OR (US); Asim Sadiq, Santa Clara, CA (US); Shreekant Thakkar, Portland, OR (US); Murali Veeramoney, Beaverton, OR (US); Truong Phan, Hillsboro, OR (US)

Correspondence Address: BUCKLEY, MASCHOFF, TALWALKAR LLC, 5 ELM STREET, NEW CANAAN, CT, 06840, US

(21) Appl. No.: 11/165,815

(22) Filed: Jun. 24, 2005

(51) Int. Cl. G06F 9/44

(52) U.S. Cl. 717/114

(57) ABSTRACT

According to some embodiments, systems and apparatus for enhanced mobile computing platforms are provided. For example, an apparatus or system may comprise a universal computational package, comprising a processor, a memory coupled to the processor, a plurality of instructions stored in the memory directed to at least one specific use of the universal computational package, and a plurality of interface controllers coupled to the processor, wherein each of the plurality of interface controllers is operable to cause the processor to execute the plurality of stored instructions in accordance with the presence of a use-specific user interface cover associated with the at least one specific use of the universal computational package.

### BACKGROUND

Mobile computing devices have continued to increase in variety, functionality, and numbers. Lighter and more compact portable computers, web tablets, digital music players, cellular telephones, and Personal Digital Assistant (PDA) devices, for example, are used throughout the consumer and business marketplaces. While some mobile platforms have merged to create more powerful and multi-functional devices, these devices fall short of offering a level of integration, ease of use, ease of manufacture, and/or user-friendly design that is required by modern users. Modularity and use-specific design or configuration, for example, are typically absent in existing mobile computing platforms. For these and other reasons, typical mobile computing platforms may not be desirable.

### BRIEF DESCRIPTION OF THE DRAWINGS

FIG. 1 is a block diagram of a system according to some embodiments.

FIG. 2 is a block diagram of a system according to some embodiments.

FIG. 3A and FIG. 3B are perspective diagrams of a system according to some embodiments.

FIG. 4 is a perspective diagram of a system according to some embodiments.

FIG. 5 is a block diagram of an apparatus according to some embodiments.

FIG. 6 is a circuit diagram of a system according to some embodiments.

FIG. 7 is a block diagram of an apparatus according to some embodiments.

FIG. 8 is a circuit diagram of a system according to some embodiments.

FIG. 9 is a block diagram of a system according to some embodiments.

### DETAILED DESCRIPTION

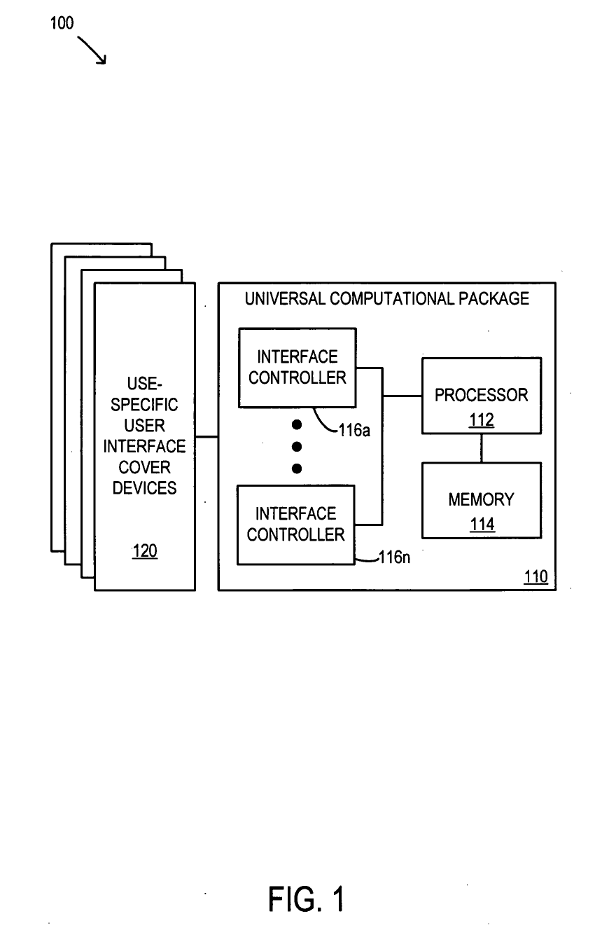

Referring first to FIG. 1, a block diagram of a system 100 according to some embodiments is shown. The various systems described herein are depicted for use in explanation, but not limitation, of described embodiments. Different types, layouts, quantities, and configurations of any of the systems described herein may be used without deviating from the scope of some embodiments. Fewer or more components than are shown in relation to the systems described herein may be utilized without deviating from some embodiments.

The system 100 may comprise, for example, a Universal Computational Package (UCP) 110. The UCP 110 may, for example, be or include various computational and/or processing components that substantially and/or entirely comprise the electrical components of a computational device such as a mobile computing platform (e.g., the system 100). According to some embodiments, the UCP 110 may comprise a processor 112, a memory 114, and/or one or more interface controllers 116a-n. The processor 112 may, for example, comprise any number of processors, which may be any type or configuration of processor, microprocessor, and/or micro-engine that is or becomes known or available. According to some embodiments, the processor 112 may be an XScale® Processor such as an Intel® PXA270 XScale® processor, an Intelg Pentium® M Processor with a Mobile Intel® 915GM/PM/GMS Express chipset, and/or any other type of processor that is or becomes known or practicable.

The memory 114 may be or include, according to some embodiments, one or more magnetic storage devices, such as hard disks, one or more optical storage devices, and/or one or more solid state storage devices. The memory 114 may store, for example, applications, programs, procedures, and/or modules that store instructions to be executed by the processor 112. The memory 114 may comprise, according to some embodiments, any type of memory for storing data, such as a Single Data Rate Random Access Memory (SDR-RAM), a Double Data Rate Random Access Memory (DDR-RAM), or a Programmable Read Only Memory (PROM).

In some embodiments, the interface controllers 116a-n may comprise any number of devices, paths, wires, cables, ports, Printed Circuit Board (PCB) devices, and/or other electrical and/or physical components configured to send, receive, transmit, and/or communicate interface signals. An interface controller 116a-n may, for example, comprise a circuit and/or device capable of receiving input signals from one of a plurality of Use-Specific User Interface Cover (USUIC) devices 120 and/or capable of transmitting such signals to the processor 112 of the UCP 110. According to some embodiments, the interface controllers 116a-n may be coupled to an USUIC device 120 and/or various components thereof. The USUIC device 120 may, for example, provide input signals to the interface controllers 116a-n to cause the processor 112 to execute instructions stored in the memory 114.

In some embodiments, the USUIC device 120 may be directed to and/or configured for a specific use. The USUIC device 120 may, for example, be a user interface cover (e.g., a “skin”) that, when coupled to the UCP 110, is operable to cause the UCP 110 to execute instructions directed to the specific use. The USUIC device 120 may, according to some embodiments, be utilized to provide an indication to one or more of the interface controllers 116a-n, for example, and the one or more interface controllers 116a-n may be directed to cause the processor 112 to execute instructions stored in the memory 114. The instructions (not shown in FIG. 1) may, for example, be directed to the specific use associated with the USUIC device 120.

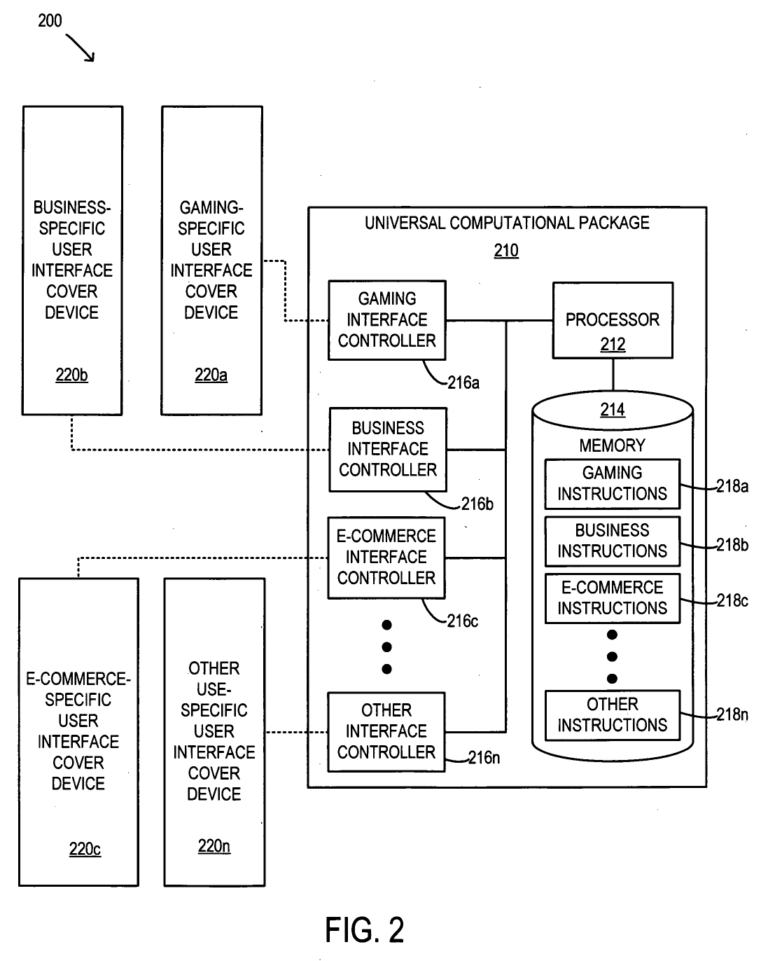

Turning in more detail to FIG. 2, for example, a block diagram of a system 200 according to some embodiments is shown. The system 200 may, for example, be similar in functionality and/or configuration to the system 100 described in conjunction with FIG. 1. In some embodiments, the system 200 may comprise a UCP 210 that comprises a processor 212, a memory 214, and/or one or more interface controllers 216a-n. In some embodiments, the memory 214 may store various instructions 218a-n capable of being executed by the processor 212. The instructions 218a-n may, for example, be directed to causing the processor 212 to perform in accordance with one or more specific uses. As shown in FIG. 2, for example, the instructions 218a-n may be directed to specific uses such as gaming applications (e.g., gaming instructions 218a), business applications (e.g., business instructions 218b), e-commerce applications (e.g., e-commerce instructions 218c), and/or other applications (e.g., other instructions 218n). In some embodiments, fewer or more components than are shown in FIG. 2 may be included in the system 200.

According to some embodiments, the use-specific instructions 218a-n may be or include any number of commands, lines of code, procedures, packages, modules, applications, files, and/or other instructions or combinations thereof that are operable to cause the processor 212 to process data or information in accordance with a specific use. For example, the gaming instructions 218a may comprise code, that when executed by the processor 212, is operable to cause the processor 212 to perform one or more computational, procedural, and/or other processing acts associated with a gaming use. In some embodiments, the gaming use may simply involve the execution of various gaming applications and/or procedures. According to some embodiments, the gaming use may also or alternatively involve configuring the UCP 210 in accordance with various gaming setups, configurations, and/or other gaming-related acts.

In some embodiments, the use-specific instructions 218a-n may be associated with the interface controllers 216a-n. The interface controllers 216a-n may, for example, comprise use-specific interface controllers 216a-n directed to the specific uses of the use-specific instructions 218a-n, respectively. According to some embodiments for example, a gaming interface controller 216a may be operable to cause the processor 212 to execute the gaming instructions 218a. The gaming interface controller 216a may, for example, comprise a set of wires and/or other circuit components that are operable to send a signal to the processor 212 to indicate that the gaming instructions 218a should be executed, initialized, and/or otherwise activated. Although the use-specific interface controllers 216a-n are shown in FIG. 2 as being paired in a one-to-one relationship with the use-specific instructions 218a-n, respectively, other configurations may also or alternatively be employed within the UCP 210. One use-specific interface controller 216a-n may, for example, be associated with the execution of multiple use-specific instructions 218a-n, or vice versa.

According to some embodiments, the system 200 may also comprise one or more USUIC devices 220a-n (e.g., a plurality of USUIC device 220a-n). In some embodiments, the USUIC devices 220a-n may be associated with one or more of the use-specific interface controllers 216a-n. As shown in FIG. 2, for example, a gaming USUIC device 220a, a business USUIC device 220b, an e-commerce device USUIC 220c, and/or an other USUIC device 220n may be associated with the gaming, business, e-commerce, and other interface controllers 216a-n, respectively (e.g., associated upon coupling to the UCP 210). For example, the gaming USUIC device 220a may be coupled to activate the gaming interface controller 216a (e.g., to cause the processor 212 to execute the gaming instructions 218a). In some embodiments, any one of the USUIC devices 220a-n may be coupled to the UCP 210. The system 200 may, for example, comprise a use-specific mobile computational platform directed to executing the use associated with the USUIC device 220a-n coupled to the UCP 210.

In some embodiments, any of the plurality of USUIC devices 220a-n may be coupled to the UCP 210 to cause the system 200 to be associated with a specific use (and/or with a plurality of specific uses). The UCP 210 may, for example, be manufactured to be compatible with any of the plurality of USUIC device 220a-n. In some embodiments, the system 200 may be defined as a “gaming system” (e.g., where gaming is the dominant and/or exclusive use) by coupling the gaming USUIC device 220a to the UCP 210. According to some embodiments, the selected USUIC device 220a-n may be coupled to the UCP 210 to electrically couple the selected USUIC device 220a-n to one or more of the use-specific interface controllers 216a-n (e.g., that are directed to a use associated with the selected USUIC device 220a-n) and/or to at least partially envelope and/or cover the UCP 210 and/or components thereof. The USUIC device 220a-n may, for example, comprise a chassis and/or cover (not shown) that is configured to mate with a chassis (also not shown) of the UCP 210 to define a mobile computational device (and/or an enclosure or body thereof). In some embodiments, the USUIC device 220a-n may be or include more structural definition than simply a portion of a chassis of the system 200. The USUIC device 220a-n may, for example, comprise and/or define substantially the entire chassis of the system 200. The UCP 210 may, for example, be or include a motherboard and/or other module or unit that is operable to fit within, slide into, snap onto, and/or otherwise couple to (and/or within) the USUIC device 220a-n.

According to some embodiments, the modular nature of the USUIC device 220a-n and of the UCP 210 may provide enhanced manufacturing and/or assembly options and/or may reduce manufacturing and/or assembly costs. Many UCP 210 devices may be produced, for example, and utilized as the electronic base for any of a wide variety of use-specific devices depending only upon which USUIC device 220a-n is coupled thereto. Standardization of the base electronics may, according to some embodiments, promote ease of manufacture and/or simplify any alterations (e.g., likely made in a modular nature) required and/or desired for any of the plurality of USUIC devices 220a-n. A gaming-specific device may, for example, include a higher capacity memory 214, for example, while otherwise maintaining the same interface controllers 216a-n and/or instructions 218a-n as other use-specific UCP 210 setups. In some embodiments, the USUIC device 220a-n may comprise any number of interface devices (not shown in FIG. 2) such as input and/or output devices. According to some embodiments, the positioning and/or configuration of these interface devices may define which of the use-specific interface controllers 216a-n are activated by a particular USUIC device 220a-n (e.g., when coupled to the UCP 210).

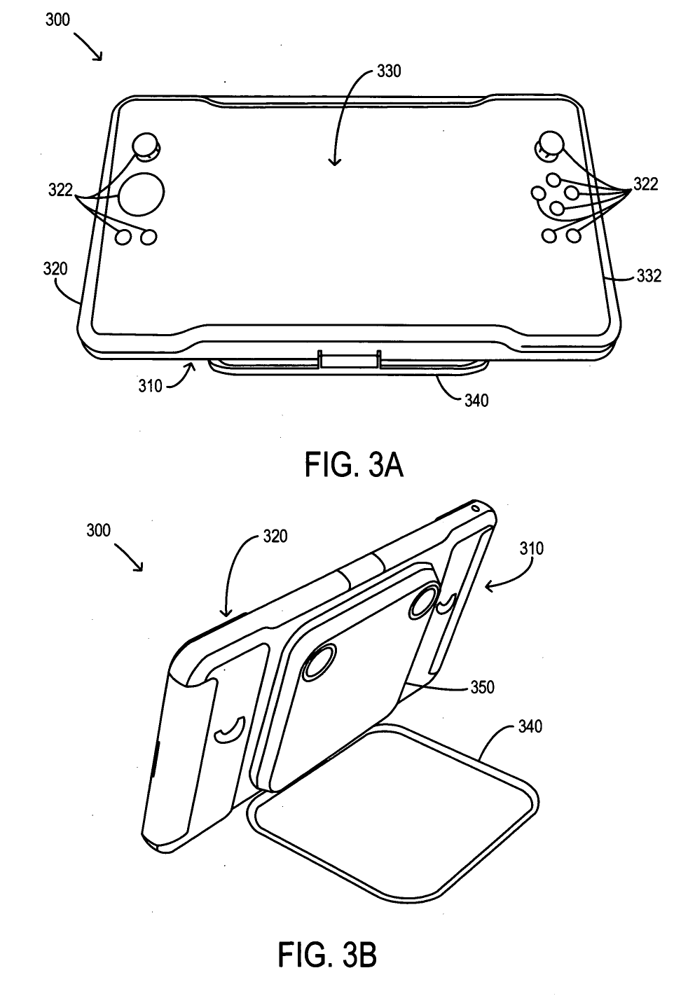

Referring to FIG. 3A and FIG. 3B, for example, perspective diagrams of a system 300 according to some embodiments are shown. In some embodiments, the system 300 may be similar in functionality and/or configuration to the systems 100, 200 described in conjunction with any of FIG. 1 and/or FIG. 2. The system 300 may, for example, be a modular mobile computing platform comprising a UCP 310 and a USUIC device 320. As shown in FIG. 3A and FIG. 3B, the combination of the UCP 310 and the USUIC device 320 may define a physical structure of the system 300 (e.g., a chassis, body and/or enclosure). The UCP 310 may, for example, comprise a rear portion of the system 300 while the USUIC device 320 may define the frontal and/or side portions of the system 300. According to some embodiments, the body, chassis, and/or structure of the system 300 may be substantially entirely defined by the USUIC device 320 and/or the UCP 310 may reside within the chassis and/or be enclosed within the USUIC device 320. In some embodiments, fewer or more components than are shown in FIG. 3A and/or FIG. 3B may be included in the system 300.

In some embodiments, the system 300 and/or the USUIC device 320 may further comprise one or more input devices 322. As shown in FIG. 3A, for example, the input devices 322 may comprise any number, type, and/or configuration of buttons, switches, toggles, joysticks, and/or any other input devices that are or become known or practicable. In some embodiments, the input devices 322 may be coupled to one or more interface controllers and/or use-specific interface controllers (not shown in FIG. 3A or FIG. 3B). The input devices 322 may, for example, be utilized to provide indications to the interface controllers to cause the UCP 310 to execute instructions associated with a specific use. According to some embodiments, the input devices 322 may be configured, located, and/or otherwise situated in accordance with the specific use. As shown in FIG. 3A, for example, the input devices 322 may be laid out on the USUIC device 320 to enhance the ease and/or functionality of a gaming use. The layout and/or selection of the input devices 322 may, for example, be chosen based upon market research regarding how users utilize and/or desire to utilize devices for gaming purposes. In some embodiments, the input devices 322 may also or alternatively be laid out in accordance with ergonomic and/or other considerations.

According to some embodiments, the layout of the input devices 322 may define which of the interface controllers are associated with the input devices 322. Certain interface controllers may, for example, be located in areas beneath the input device 322 and the coupling of the USUIC device 320 to the UCP 310 may electrically couple any input devices 322 to any interface controllers residing in areas underneath and/or near the input device 322. In other words, the locations of the interface controllers (e.g., the interface controllers 116a-n, 216a-n) may be determined to coordinate with the use-specific locations of input devices 322 on the USUIC device 320. Other non-gaming interface controllers may reside under other unused portions of the USUIC device 320, for example, and may accordingly not be coupled to any of the input devices 322 of the gaming-specific USUIC device 320. Other USUIC devices 320 may be coupled to the UCP 310, however, to activate other and/or additional use-specific interface controllers within the system 300 and/or the UCP 310.

In some embodiments, the system 300 may also or alternatively comprise a touch screen 330 having an interface surface 332. The touch screen 330 and/or the interface surface 332 may, for example be utilized to activate interface controllers of the system 300 and/or the UCP 310, and/or may be otherwise utilized to interact with, control, and/or command the system 300. The interface surface 332 may, according to some embodiments, be an input and/or an output surface. The interface surface 332 may, for example, allow a user to interface with the system 300 via touch and/or may provide information to the user (such as via a display). In some embodiments, the interface surface 332 may comprise a display screen such as a Liquid Crystal Display (LCD) and/or may comprise one or more contacts (not shown) associated with receiving input via touch. The contacts may, for example, be located within and/or underneath the interface surface 322. According to some embodiments, the interface surface 322 may extend substantially to the extents of the touch screen 330, the USUIC device 320, and/or the system 300.

The interface surface 332 may, for example, comprise contacts that permit substantially the entire face and/or side of the system 300 to be utilized as a touch interface and/or display. In some embodiments, the interface surface 332 may also or alternatively be shaped and/or formed to comprise substantially the entire surface of the system 300. Whereas typical touch screen devices are square and/or rectangular in configuration (possibly with a cover and/or other device hiding the sharp edges), for example, the touch screen 330 and/or the interface surface 332 may be formed in various smooth, circular, rounded, and/or other shapes and/or combinations thereof, as desired. The touch screen 330 and/or the interface surface 332 may, for example, be aesthetically and/or functionally shaped to comprise substantially an entire side and/or surface of the system 300 (and/or of the USUIC device 320). In some embodiments, the touch screen 330 may also or alternatively comprise a diaphragm of a speaker. The touch screen 330 may, for example, be utilized to facilitate the generation of voice, music, and/or other sounds associated with the operation of the system 300. According to some embodiments, one or more portions of the touch screen 330 may be utilized as speaker diaphragms and/or other sound-generation components.

In some embodiments, the system 300 may also or alternatively comprise other features and/or components. The system 300 may comprise, for example, a retractable and/or folding stand 340. The retractable stand 340 may, for example, be a device coupled via a hinge to the system 300, the USUIC device 320, and/or the UCP 310. In some embodiments, the retractable stand 340 may be moveably positioned in various orientations. The retractable stand 340 may, for example, be folded up against, retracted into, and or deployed from the system 300 (and/or the chassis or body thereof). According to some embodiments, the retractable stand 340 may be deployed to allow the system 300 to be positioned on a substantially planar surface, for example, such that the touch screen 330 may be oriented in a manner similar to a traditional TV or computer monitor (e.g., for desktop viewing and/or use). The retractable stand 340 may be stowed, removed, retracted, folded, and/or otherwise un-deployed, according to some embodiments, to allow the system 300 to be more easily transported, stored, and or utilized as a “laptop” in a tablet configuration.

In some embodiments, the system 300 may comprise an accessory module 350. The accessory module 350 may, as shown in FIG. 3B, for example, be a device that is removably coupled to the back of the system 300, the chassis thereof, and/or to the UCP 310 (and/or a chassis thereof). According to some embodiments, the accessory module 350 may be or include a device such as a Digital Video Disk (DVD) player or Compact Disk (CD) drive, a memory device (such as a removable hard drive), a communications device (such as a wireless and/or satellite device), a power supply (such as a battery), and/or any other device or combination of devices that is or becomes practicable.

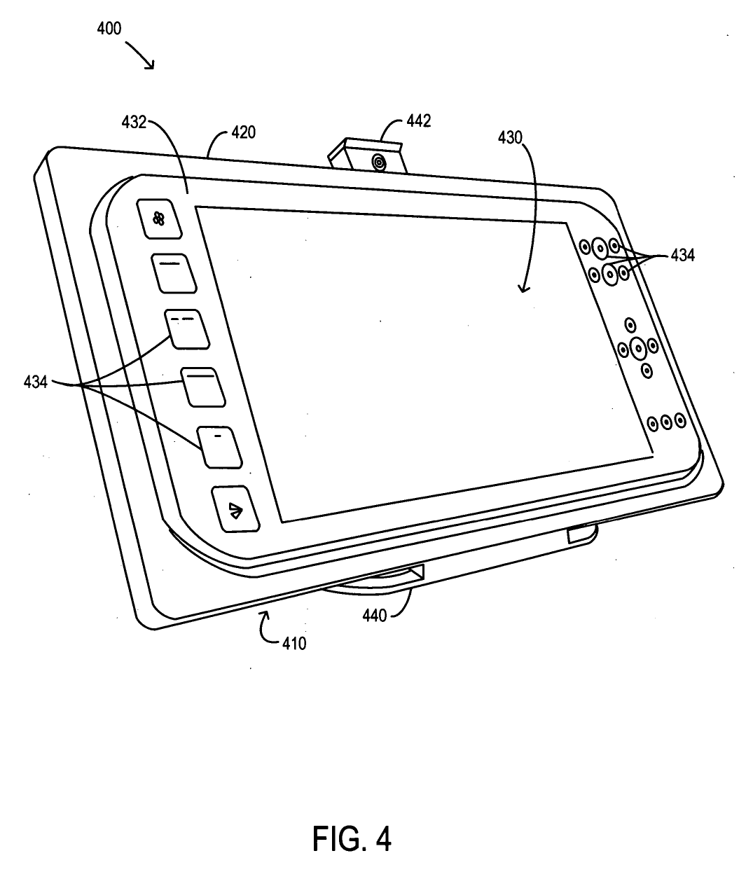

Turning now to FIG. 4, a perspective diagram of a system 400 according to some embodiments is shown. The system 400 may, for example, be similar in functionality and/or configuration to the systems 100, 200, 300 described in conjunction with any of FIG. 1, FIG. 2, FIG. 3A, and/or FIG. 3B herein. In some embodiments the system 400 may be or include a mobile computational platform. The system 400 may comprise, for example, a UCP 410, a USUIC device 420, and/or a touch screen 430. The touch screen 430 may, according to some embodiments, be similar to the touch screen 330 described in conjunction with FIG. 3A herein. The touch screen 430 may comprise, for example, an interface surface 432 and/or one or more interface areas 434. In some embodiments, fewer or more components than are shown in FIG. 4 may be included in the system 400.

According to some embodiments, the interface areas 434 of the touch screen 430 may be or include areas of the touch screen 430 and/or of the interface surface 432 that are associated with performing various tasks and/or executing certain commands. The interface areas 434 may, for example, be areas defining one or more soft-keys that change functionality based upon the current display of the touch screen 430. The interface areas 434 may also or alternatively be or include areas that may be defined and/or programmed by a user in accordance with the user's needs and/or desires. In other words, the interface areas 434 may be dedicated touch button areas of the interface surface 432 that may be defined and/or configured as needed and/or as desired (e.g., they may not change functionality based upon content of the touch screen 430). According to some embodiments, the interface areas 434 may be coupled to a controller (not shown) that is capable of managing signals received via the interface surface 432.

The controller may, for example, be a software controller (e.g., stored in memory of the UCP 410) that is configured to receive indications associated with input received via the interface surface 432 and/or via the interface areas 434. In some embodiments, the software controller may be operable to interpret signals received from the interface areas 434. The software controller may, for example, cause a processor (such as the processor 112, 212) of the UCP 410 to execute instructions associated with the interface areas 434. In some embodiments, the software controller may also be operable to deactivate areas of the interface surface 432. In the case that an input indication is received from an area of the interface surface 432 near, at, and/or adjacent to one of the interface areas 434, for example, the software controller may deactivate the areas surrounding the interface areas 434. This may, for example, substantially prevent a touch input intended for one of the interface areas 434 from being interpreted as an indication associated with another interface area 434 and/or with a different portion of the non-dedicated interface surface 432. In other words, the software controller may interpret touch screen 430 input to substantially prevent inaccurate touch inputs from unnecessarily and/or undesirably activating an unintended interface controller. In some embodiments, the deactivation by the software controller may be associated with various indications. The interface areas 434 and/or other portions of the interface surface 432 may, for example, comprise electro-luminescent material that may provide visual (e.g., light) indications associated with a user's touch (e.g., selection of an interface areas 434) and/or with the deactivation of surrounding portions of the interface surface 432.

In some embodiments, the system 400 may comprise a stand 440 and/or a camera 442. The stand 440 may, for example, be similar to the retractable stand 340 described in conjunction with FIG. 3A and FIG. 3B. The stand 440 may, according to some embodiments, be removable (e.g., as opposed to retractable). The stand 440 may, for example, be a device that snaps onto and/or otherwise mechanically couples to the apparatus 400 to facilitate standard desktop viewing orientations. In some embodiments, the stand 440 may be or include a docking station and/or similar device that not only orients the system 400 for standard desktop and/or other viewing but also provides power and/or other electrical interfaces or connectors with which the system 400 may couple.

The camera 442 may, in some embodiments, be a retractable camera 442 as shown in FIG. 4. The camera 442 may, for example, be or include a digital still image and/or a digital video camera coupled to the UCP 410 and/or to the USUIC device 420. The camera 442 may, for example, be included only on those USUIC devices 420 that may be associated with camera usage (e.g., gaming, graphical design and/or editing, photo editing, and/or remote meeting USUIC devices 420), while the UCP 410 may simply comprise a connector (not shown) operable to interface with the camera 442 in the case that is present. The camera 442 may be retractable for convenience and/or for protection from dust and/or traveling or transportation damage. In some embodiments, the camera 442 may be substantially smaller and/or more low-profile than standard cameras. The camera 442 may, for example, be configured to include slim components and/or a slim profile such that the camera 442 may retract into the apparatus 442. According to some embodiments, the camera 442 may receive power from the UCP 410. The connector in the UCP 410 operable to couple to the camera 442 may, for example, comprise a Universal Serial Bus (USB) connector capable of managing signals in accordance with the USB Specification Revision 2.0 (2000). The camera 442 may also or alternatively be configured to be coupled to an interface controller of the UCP 410. The interface controller may, for example, automatically activate the camera 442 in accordance with use-specific instructions being executed by the system 400. In some embodiments, the retraction of the camera 442 may automatically trigger power state management of the camera 442. The camera 442 may be deactivated and/or set to a “power-saving” mode, for example, to conserve power when the camera 442 is not being actively utilized (e.g., in the case that the camera 442 is retracted).

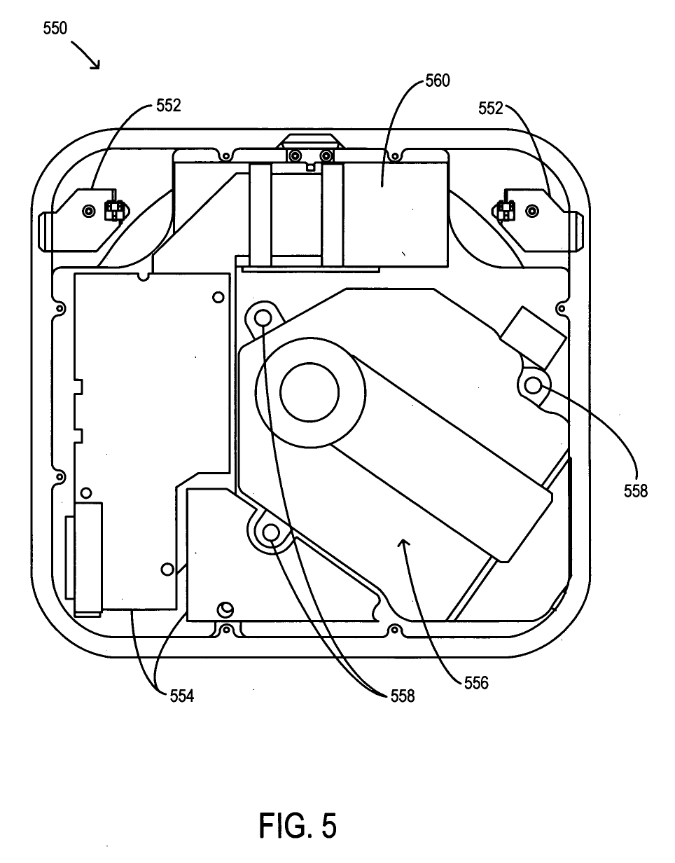

Referring to FIG. 5, a block diagram of an apparatus 550 according to some embodiments is shown. The apparatus 550 may, for example, be or include a module such as the accessory module 350 configured to be coupled to one of the systems 100, 200, 300, 400 described herein. In some embodiments, the apparatus 550 may be or include a DVD player and/or module. The apparatus 550 may, for example, be a DVD module operable to be removably and/or securely attached to a mobile computational platform such as a platform including a UCP and/or a USUIC. According to some embodiments, the apparatus 550 may be configured to be removably attached to the back of a mobile platform as described herein. The apparatus 550 may, for example, comprise one or more latching mechanisms 552 to couple the apparatus 550 to a mobile platform. In some embodiments, fewer or more components than are shown in FIG. 5 may be included in the apparatus 550.

In some embodiments, a chassis (not shown) of a mobile platform (and/or of a UCP or a USUIC) may be configured to accept the apparatus 550. The apparatus 550 may, for example, slide into one or more channels, detents, and/or other guiding or mounting brackets, mechanisms or structures on the chassis. The latching mechanisms 552 may, for example, engage to couple the apparatus 550 to the chassis in the case the apparatus 550 is positioned properly with respect to the chassis. The apparatus 550 may snap into place, for example, securely mechanically and/or electrically coupling the apparatus 550 to the mobile platform. The latching mechanisms 552 and/or the mounting of the apparatus 550 in general may, for example, cause the apparatus 552 to be electrically coupled to a UCP.

The apparatus 550 may, according to some embodiments, comprise module electronics 554. In the case that the apparatus 550 is a DVD module, for example, the module electronics 554 may comprise DVD electronics for processing, encoding, decoding, playing, recording, and/or otherwise managing DVD information. In some embodiments, the apparatus 550 may comprise a drive mechanism 556 such as a DVD drive mechanism for spinning a DVD. According to some embodiments, the drive mechanism 556 may be dampened from vibrations (e.g., of the mobile platform) via utilization of a vibration isolation mechanism 558. In some embodiments, the components of the apparatus 550 may be low-profile in configuration to reduce the distance that the apparatus 550 may extend off the back of the mobile platform. The drive mechanism 556 and the vibration isolation mechanism 558, for example, may be low-profile components configured to deliver vibration isolated DVD processing via low-profile modular package.

According to some embodiments, the apparatus 550 may also or alternatively comprise conversion electronics 560. The conversion electronics 560 may serve several functions. The conversion electronics 560 may, for example, allow the apparatus 550 to receive power from the mobile platform (e.g., via USB). In some embodiments, the conversion electronics 560 may also or alternatively convert Intelligent Drive Electronics (IDE) signals received from the module electronics 554 into USB signals to be transmitted to the mobile platform. In such a manner, for example, the apparatus 550 may be capable of connecting to the mobile platform via a standard USB interface and/or may be capable of being powered via USB power signals provided by the mobile platform.

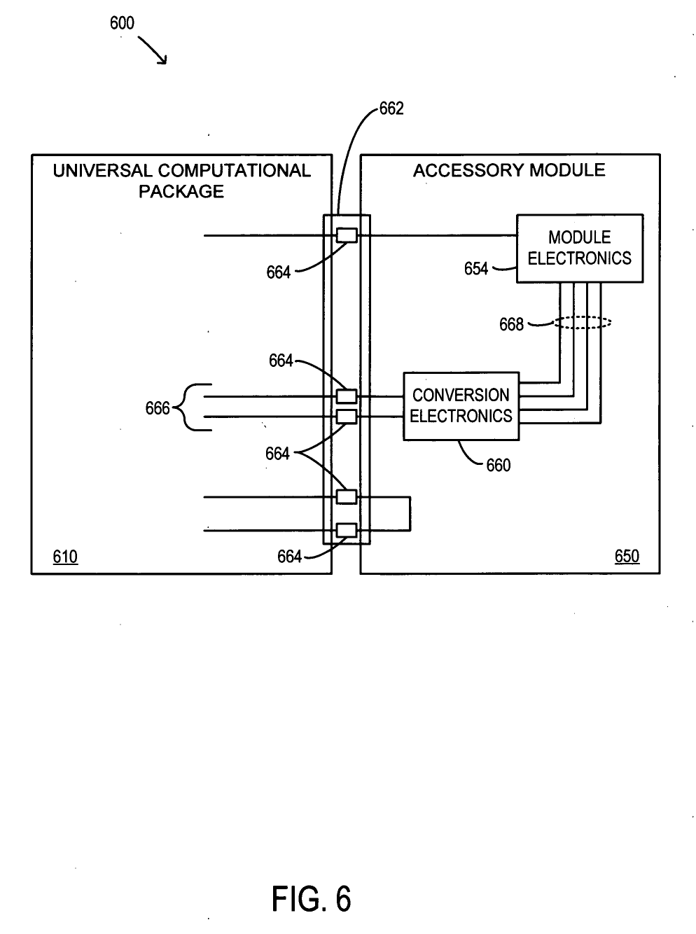

Turning to FIG. 6, for example, a circuit diagram of a system 600 according to some embodiments is shown. The circuit diagram of the system 600 may show, for example, various electrical connections and/or devices associated with the accessory module apparatus 550 described in conjunction with FIG. 5. According to some embodiments, the system 600 may comprise a UCP 610 coupled to an accessory module 650. The accessory module 650 may, for example, be a DVD and/or other module coupled to the UCP 610 of a mobile platform (e.g., the system 600). In some embodiments, the accessory module 650 may comprise module electronics 654 and/or conversion electronics 660. In some embodiments, fewer or more components than are shown in FIG. 6 may be included in the system 600.

According to some embodiments, such as in the case that the accessory module 650 comprises a DVD device, the module electronics 654 may be or include DVD electronics and/or the conversion electronics 660 may comprise IDE-to-USB conversion electronics. In some embodiments, the accessory module 650 may be physically and/or electronically coupled to the UCP 610 (e.g., as described elsewhere herein). The accessory module 650 and/or the UCP 610 may, for example, comprise, define, and/or be associated with a connector 662. The connector 662 may, according to some embodiments, be or include one or multiple components (e.g., male and female portions). In some embodiments, the connector 662 may comprise one or more pins 664. The pins 664 may, for example, be or include electrical contacts associated with either or both of the UCP 610 and the accessory module 650.

In some embodiments, the pins 664 may comprise multiple portions. One portion of a pin 664 may be associated with and/or coupled to the UCP 610, for example, while another portion of the pin 664 may be associated with and/or coupled to the accessory module 650. In the case that the connector 662 is engaged, mated, and/or coupled to form an electrical connection between the UCP 610 and the accessory module 650, for example, the portions of respective pins 664 may engage, mate, and/or otherwise couple to form electrical connections. According to some embodiments, the electrical coupling facilitated by the connector 662 and/or the pins 664 thereof may also provide and/or facilitate physical coupling of the UCP 610 and the accessory module 650.

In some embodiments, such as sown in FIG. 6, the connector 664 may be associated with five pins 662. According to some embodiments, some pins 664 may provide a detect function that allows the UCP 610 to detect the presence and/or coupling of the accessory module 650. Pins 664 may also or alternatively provide a USB connection 666 between the UCP 610 and the conversion electronics 660 of the accessory module 650. The conversion electronics 660 may, for example, receive IDE signals via and IDE connection 668 with the module electronics 654 and convert the IDE signals to USB signals to be provided to the UCP 610 via the USB connection 666. The conversion electronics 660 may also or alternatively provide USB and/or other power (e.g., via the USB connection 666 and/or via other connections and/or pins) to power the accessory module 650.

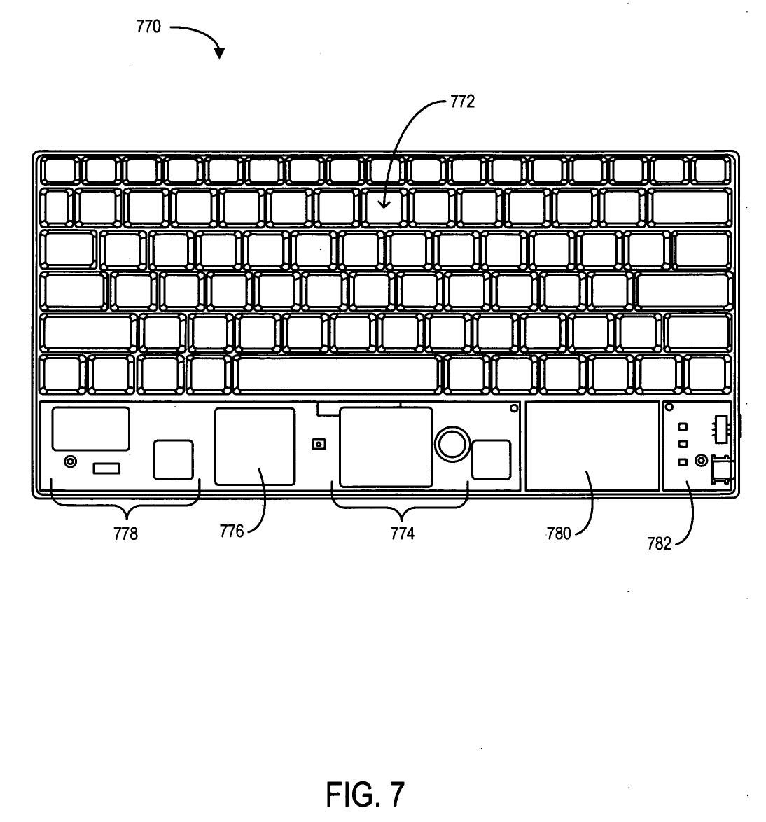

Referring now to FIG. 7, a block diagram of an apparatus 770 according to some embodiments is shown. The apparatus 770 may, for example, be or include a keyboard portion 772 and/or a mouse portion 774. In some embodiments, the apparatus 700 may be a wireless keyboard and mouse 772, 774 combination coupled to provide wireless input to a mobile platform such as the systems 100, 200, 300, 400 described herein. The keyboard portion 772 may, according to some embodiments, comprise any type or configuration of keyboard such as a scan matrix keyboard and associated input keys. The mouse portion 774 may also be or include any type of mouse or pointing device that is or becomes known or practicable. As shown in FIG. 7, for example, the mouse portion 774 may comprise a touch pad portion and a select button portion typical to mobile computing pointing devices integrated with keyboards. In some embodiments, the pointing and selection functions of the mouse portion 774 may be integrated into a single device and/or may include components providing more detailed and/or additional functionality, as desired.

In some embodiments, the apparatus 770 may comprise a microcontroller 776 to manage signals sent to and/or received from the keyboard and mouse portions 772, 774. The microcontroller 776 may, for example, manage signals received from the keyboard and mouse portions 772, 774 and provide such signals to a single wireless Bluetooth® transceiver 778. The single wireless Bluetooth® transceiver 778 may, for example, send and receive wireless signals associated with both the keyboard and mouse portions 772, 774 of the apparatus 770. In some embodiments, these wireless signals may be provided and/or directed to a mobile computing platform as described herein. The signals may be sent, for example, to a wireless device (not shown) of a UCP portion of a mobile platform. According to some embodiments, either or both of the microcontroller 776 and the single Bluetooth® transceiver 778 may manage multiple signals from either or both of the keyboard and mouse portions 772, 774 (e.g., via multiplexing and/or other signal management or processing techniques).

According to some embodiments, the apparatus 770 may comprise a battery 780 and/or a control circuit 782. The battery 780 may, for example, be or include any type of power source that is or becomes known or practicable. The battery 780 may, for example, be or include a Lithium-Ion (Li-ion), Nickel-Cadmium (NiCad), and/or a Nickel-Metal Hydride (NiMH) battery and/or battery cells. In some embodiments, the battery 780 may provide power to either or both of the microcontroller 776 and/or the single Bluetooth® transceiver 778. According to some embodiments, the battery 780 may be recharged, supplemented, and/or replaced (e.g., temporarily) via the control circuit 782. The control circuit 782 may, for example, couple to another power source and/or device to provide power to re-charge the battery 780 and/or to provide power to the apparatus 770 to preserve power already stored within the battery 780.

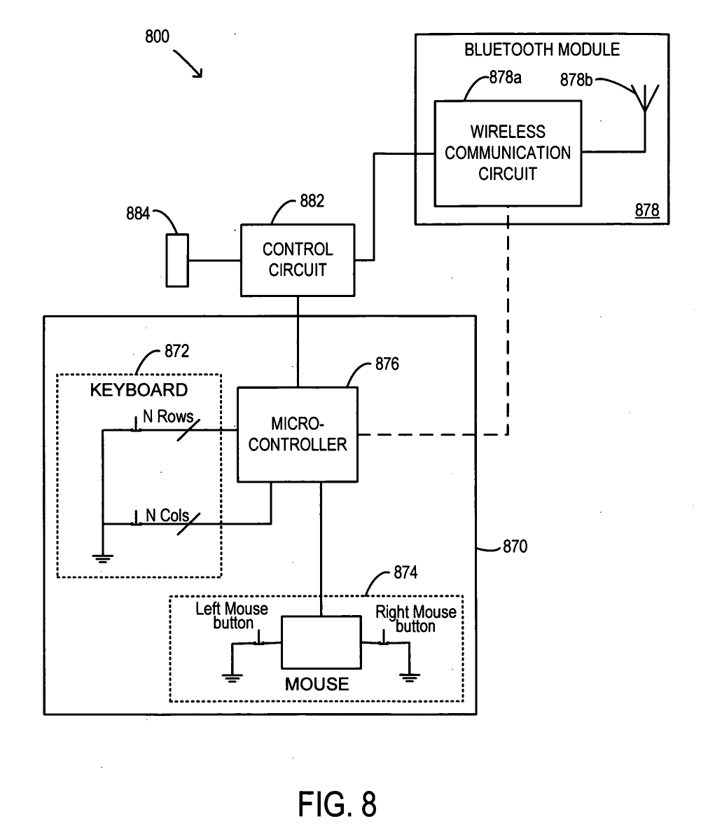

Turning to FIG. 8, a circuit diagram of a system 800 according to some embodiments is shown. The circuit diagram of the system 800 may show, for example, various electrical connections and/or devices associated with the wireless keyboard and mouse apparatus 770 described in conjunction with FIG. 7. According to some embodiments, the system 800 may comprise a wireless keyboard and mouse combination device 870. The wireless keyboard and mouse combination device 870 may comprise, according to some embodiments, a keyboard portion 872, a mouse portion 874, and/or a microcontroller 876 coupled to communicate with the keyboard and mouse portions 872, 874. The system 800 may also comprise a single Bluetooth® transceiver 878 to send and receive wireless signals associated with the keyboard and mouse portions 872, 874 (e.g., provided to the single Bluetooth® transceiver 878 via the microcontroller 876). In some embodiments, the single Bluetooth® transceiver 878 may comprise a wireless communication circuit 878a and/or a single antennae 878b. In some embodiments, the system 800 may also comprise a control circuit 882 and/or a connector 884. In some embodiments, fewer or more components than are shown in FIG. 8 may be included in the system 800.

In some embodiments, the keyboard portion 872 may comprise a scan matrix and/or other type of keyboard that is coupled to and/or interfaced with the microcontroller 876. The microcontroller 876 may, for example, comprise a scan matrix and/or other input to facilitate communication with the keyboard portion 872. According to some embodiments, the mouse portion 874 may comprise a PS/2, serial, and/or other pointing device that is coupled to and/or interfaced with the microcontroller 876. The microcontroller 876 may, for example, comprise a PS/2 and/or other input to facilitate communication with the mouse portion 874.

According to some embodiments, the microcontroller 876 may provide and/or send the signals from the keyboard and/or mouse portions 872, 874 to the single Bluetooth® transceiver 878 and/or the wireless communication circuit 878a thereof. The microcontroller 876 may, for example, multiplex, combine, encode, and/or otherwise convert, manage, and/or process the signals received from the keyboard and mouse portions 872, 874 to allow the single Bluetooth® transceiver 878 to function as a wireless communications device for both of the portions 872, 874. In some embodiments, the wireless communication circuit 878a may, for example, de-multiplex, decode, and/or otherwise process the signals to utilize the single antenna 878b to communicate the signals to other devices, systems, and/or apparatus.

In some embodiments, the microcontroller 876 and the single Bluetooth® transceiver 878 (and/or the wireless communication circuit 878a thereof) may be coupled via a serial and/or other connection. According to some embodiments, the control circuit 882 may also or alternatively be in communication and or be serially coupled to either or both of the microcontroller 876 and/or the single Bluetooth® transceiver 878. The control circuit 882 may, for example, function as a conversion module and/or connection detector. In the case that the system 800 is coupled to another device via the connector 884, for example, the control circuit 882 may detect and/or recognize the coupling and may re-route signals from the microcontroller 876 to the connector 884 (e.g., to provide a “wired” connection). In some embodiments, the connector 884 may comprise a USB connector and/or the control circuit 882 may perform USB conversion services. The connector 884 and/or the control circuit 882 may also, for example, provide USB power to the system 800.

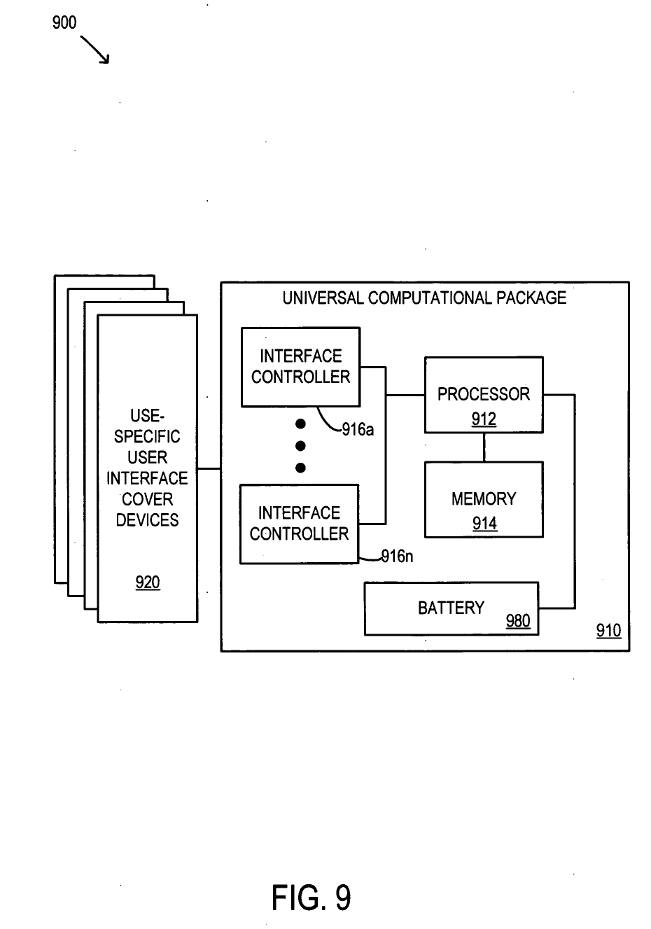

Turning to FIG. 9, a block diagram of a system 900 according to some embodiments is shown. In some embodiments, the system 900 may be similar to the systems 100, 200, 300, 400 described in conjunction with any of FIG. 1, FIG. 2, FIG. 3A, FIG. 3B, and/or FIG. 4. The system 900 may comprise, for example, a UCP 910. According to some embodiments, the UCP 910 may comprise a processor 912, a memory 914, and/or one or more interface controllers 916a-n. The system 900 may also comprise a USUIC device 920 (e.g., selected from a plurality of available USUIC devices 920) coupled to the UCP 910. In some embodiments, the UCP 910 may also comprise a battery 980. According to some embodiments, the components 910, 912, 914, 916, 920, 980 of the system 900 may be similar in configuration and/or functionality to the similarly-named components described in conjunction with any of FIG. 1, FIG. 2, FIG. 3A, FIG. 3B, and/or FIG. 4. In some embodiments, fewer or more components than are shown in FIG. 9 may be included in the system 900.

The processor 912 may be or include any number of processors, which may be any type or configuration of processor, microprocessor, and/or micro-engine that is or becomes known or available. According to some embodiments, the processor 912 may be an XScale® Processor such as an Intel® PXA270 XScale® processor, an Intel® Pentium® M Processor with a Mobile Intel® 915GM/PM/GMS Express chipset, and/or any other type of processor that is or becomes known or practicable. The memory 914 may be or include, according to some embodiments, one or more magnetic storage devices, such as hard disks, one or more optical storage devices, and/or solid state storage. The memory 914 may store, for example, applications, programs, procedures, and/or modules that store instructions to be executed by the processor 912. The memory 914 may comprise, according to some embodiments, any type of memory for storing data, such as a Single Data Rate Random Access Memory (SDR-RAM), a Double Data Rate Random Access Memory (DDR-RAM), or a Programmable Read Only Memory (PROM).

In some embodiments, the battery 980 may supply power to the processor 912 and/or otherwise to the UCP 910. The battery 980 may also or alternatively, for example, provide power to the USUIC device 920 coupled to the UCP 910 (e.g., in the case that the USUIC device 920 comprises a Light-Emitting Diode (LED), illuminated touch screen, and/or other power-requiring device not shown in FIG. 9). According to some embodiments, any one of a plurality of the USUIC devices 920 may be coupled to the UCP 910. In such a manner, for example, manufacturing and/or assembly may be simplified by the ability to utilize a single, universal electronics core (e.g., the UCP 910) as the base for any of a variety of specific-user devices (e.g., defined by the USUIC device 920 that is ultimately coupled to the UCP 910). In some embodiments, the system 900 may also comprise one or more accessory modules (such as the accessory modules 350, 550, 650) and/or a wireless keyboard and mouse device utilizing a single Bluetooth® transceiver and/or antennae (such as the wireless keyboard/mouse apparatus 770, 870).

The several embodiments described herein are solely for the purpose of illustration. Other embodiments may be practiced with modifications and alterations limited only by the claims.

What is claimed is:

1. An apparatus, comprising:
a universal computational package, comprising:
a processor;
a memory coupled to the processor;
a plurality of instructions stored in the memory directed to at least one specific use of the universal computational package; and
a plurality of interface controllers coupled to the processor, wherein each of the plurality of interface controllers is operable to cause the processor to execute the plurality of stored instructions in accordance with the presence of a use-specific user interface cover associated with the at least one specific use of the universal computational package.

2. The apparatus of claim 1, further comprising:
the use-specific user interface cover, wherein the use-specific user interface cover is coupled to at least partially enclose the computational package, and wherein the use-specific user interface cover comprises one or more use-specific user interface devices coupled to provide an indication to the plurality of interface controllers of the computational package, wherein the indication is directed to the at least one specific use of the universal computational package.

3. The apparatus of claim 2, wherein the use-specific user interface cover is selected from a plurality of use-specific user interface covers directed to causing the universal computational package to execute the plurality of stored instructions in accordance with one of a plurality of specific uses of the universal computational package.

4. The apparatus of claim 3, wherein a position of the one or more use-specific user interface devices on the use-specific user interface cover determines which of the one or more of the plurality of interface controllers is provided with the indication.

5. The apparatus of claim 1, wherein the at least one use associated with the use-specific interface cover comprises a gaming use.

6. The apparatus of claim 1, wherein the one or more use-specific user interface devices of the use-specific user interface cover comprise a touch screen comprising a touch screen surface.

7. The apparatus of claim 6, wherein the touch screen surface extends substantially to the extents of the touch screen.

8. The apparatus of claim 7, wherein the touch screen surface comprises substantially an entire surface of the use-specific user interface cover and wherein the use-specific user interface cover comprises substantially an entire side of the apparatus.

9. The apparatus of claim 6, wherein the touch screen comprises one or more dedicated touch button areas on the touch screen surface, and wherein at least one portion of the touch screen comprises a diaphragm of a speaker.

10. The apparatus of claim 9, wherein the universal computational package further comprises:
a software controller to receive indications from the touch screen surface and to determine if an indication is associated with the one or more dedicated touch button areas.

11. The apparatus of claim 10, wherein the software controller is operable to execute the plurality of stored instructions in response to receiving an indication from the touch screen surface.

12. The apparatus of claim 10, wherein the software controller is further to deactivate portions of the touch screen adjacent to the one or more dedicated touch screen button areas.

13. The apparatus of claim 1, further comprising:
a retractable camera device coupled to provide image information to the universal computational package.

14. The apparatus of claim 13, wherein the retractable camera device comprises a universal serial bus camera powered by the universal computational package.

15. The apparatus of claim 1, further comprising:
a retractable stand.

16. The apparatus of claim 1, further comprising:
a detachable universal serial bus module, comprising:
an interface controller coupled at least to provide information to the universal computational package and to receive power from the universal computational package;
a latching component to couple the detachable universal serial bus module to at least one of the universal computational package or the use-specific user interface cover, wherein the latching component facilitates the receipt of power and the providing of information; and
a switch to provide an indication in the case that the detachable universal serial bus module is coupled to the at least one of the universal computational package or the use-specific user interface cover.

17. The apparatus of claim 16, wherein the detachable universal serial bus device further comprises:
a low-profile vibration isolation device.

18. The apparatus of claim 16, wherein the detachable universal serial bus module comprises at least one of a digital video disk device, a television tuning device, a wireless device, a global positioning system device, a power device, or a mass storage device.

19. The apparatus of claim 1, further comprising:
a wireless input device comprising a wireless keyboard and a wireless mouse.

20. The apparatus of claim 19, wherein the wireless input device further comprises a single Bluetooth module and a controller operable to utilize the single Bluetooth module to send and receive signals associated with both the wireless keyboard and the wireless mouse.

21. A system, comprising:
a universal computational package, comprising:
a processor;
a memory coupled to the processor;
a plurality of instructions stored in the memory directed to at least one specific use of the universal computational package; and
a plurality of interface controllers coupled to the processor, wherein each of the plurality of interface controllers is operable to cause the processor to execute the plurality of stored instructions in accordance with the presence of a use-specific user interface cover associated with the at least one specific use of the universal computational package; and
a battery coupled to provide power to the universal computational package.

22. The system of claim 21, further comprising:
the use-specific user interface cover, wherein the use-specific user interface cover is coupled to at least partially enclose the computational package, and wherein the use-specific user interface cover comprises one or more use-specific user interface devices coupled to provide an indication to the plurality of interface controllers of the computational package, wherein the indication is directed to the at least one specific use of the universal computational package.

23. The system of claim 22, wherein the use-specific user interface cover is selected from a plurality of use-specific user interface covers directed to causing the universal computational package to execute the plurality of stored instructions in accordance with one of a plurality of specific uses of the universal computational package.

24. A method, comprising:
storing instructions in a memory of a universal computational package, wherein the instructions are operable to cause a processor of the universal computational package to perform in accordance with a specific use;
coupling an interface controller to the processor of the universal computational package, wherein the interface controller is operable to send a first signal to cause the processor to execute the stored instructions; and
coupling a use-specific user interface cover to the interface controller of the universal computational package, such that a second signal sent from the use-specific user interface cover is operable to cause the interface controller to send the first signal to the processor.

25. The method of claim 24, wherein the coupling of the use-specific user interface cover to the interface controller is based at least in part on a location of an input device of the use-specific interface cover.

26. The method of claim 25, wherein the stored instructions comprise a plurality of stored instructions directed to a plurality of specific uses of the universal computational package, and wherein the use-specific user interface cover is selected from a plurality of use-specific user interface covers directed to causing the processor of the universal computational package to execute one or more of the plurality of stored instructions in accordance with one of a plurality of specific uses of the universal computational package.
